(19) United States
(12) Patent Application Publication
(10) Pub. No.: US 2026/0369166 A1
(43) Pub. Date: Nov. 19, 2026

(54) Method for Operating a Parking Assistance System, Computing Device for an Ego Vehicle, Computer-Readable Storage Medium, and Parking Assistance System

(71) Applicant: Bayerische Motoren Werke Aktiengesellschaft, Muenchen (DE)

(72) Inventors: Michael STROEBEL, Groebenzell (DE); Maria SZATKOWSKA-ZIAJA, Muenchen (DE)

(21) Appl. No.: 19/138,722

(22) PCT Filed: Nov. 13, 2023
(86) PCT No.: PCT/EP2023/081642

§ 371 Date: Jun. 13, 2025

(30) Foreign Application Priority Data
Dec. 14, 2022 (DE) 10 2022 133 207.1

(51) Int. Cl. G08G 1/14; H04W 4/46

(52) U.S. Cl. CPC G08G 1/147; H04W 4/46

(57) ABSTRACT

The invention relates to a method for operating a parking assistance system of an ego vehicle during an at least partially automated search for a parking space. The method may include receiving environment data from an environment sensor, describing an environment of the ego vehicle; receiving parking space data from a front vehicle, wherein the parking space data describe potential parking spaces in front of the ego vehicle; and determining a parking space located in front of the ego vehicle using the environment data and the parking space data. In the method, the environment data describes a relative position of the front vehicle and, depending on the relative position, a driving strategy is determined for the ego vehicle for the at least partially automated search for parking spaces, according to which the environment data will be recorded in the future.

### BACKGROUND AND SUMMARY

The present invention relates to a method for operating a parking assistance system. In addition, the present invention relates to a computing device for a vehicle for carrying out such a method. Finally, the present invention relates to a computer-readable storage medium and to a parking assistance system.

Modern assistance systems for vehicles now assist the driver of the vehicle with various tasks. In particular, modern vehicles have so-called parking assistance systems which take over the longitudinal and/or lateral guidance during a maneuver. In other words, modern vehicles can therefore already nowadays maneuver the vehicle in an at least partially automated manner during a parking process.

For this purpose, a parking space is usually first of all captured when passing. The parking space can be captured when passing using radar, lidar or ultrasonic sensors and/or cameras, for example. Objects, in particular parked vehicles at the edge of the road, may be entered for this purpose in a digital environment map which describes the environment of the vehicle. The distances between the objects can therefore be used to determine whether the available space is suitable for a parking maneuver.

The disadvantage of this is often that the parking space must initially be captured when passing. Further developments of modern parking assistance systems therefore exchange information relating to available parking spaces with one another, for example via a backend or direct vehicle-to-vehicle communication.

The document DE 10 2016 113 948 A1 describes relates to a method for operating a driver assistance system of a motor vehicle, in which object data are received from a further vehicle using the driver assistance system, wherein the object data describe an object in an environment of the further vehicle and a position of the object, and the driver assistance system is operated on the basis of the received object data, wherein a relative position between the motor vehicle and the further vehicle is determined and a relative position between the motor vehicle and the object is determined using the driver assistance system on the basis of the relative position between the motor vehicle and the further vehicle and the object data.

The published patent application DE 10 2014 009 627 describes a method for reporting a free parking space for a vehicle, which is detected by a first vehicle, and a message relating to the free parking space is provided for further vehicles. In a method, the detected free parking space is checked by the detecting vehicle in order to determine whether a message to other vehicles is useful, and the message relating to the free parking space is forwarded if the message is considered to be useful. In this case, the vehicle detecting the parking space activates a search mode for capturing the parking space when there are conditions for activating the search mode for the parking space.

The object of the present invention is to show a solution of how parking assistance systems, which receive information relating to parking spaces from further road users and/or from a backend, can be improved beyond the prior art.

This object is achieved, according to the invention, by means of a method, a computing device, a computer-readable storage medium and a parking assistance system having the features according to the independent claims. Advantageous developments of the present invention are specified in the dependent claims.

Within the context of the document, the term “automated driving” is understood to mean driving with automated longitudinal and/or lateral guidance. Automated driving may involve, for example, driving on the freeway for a longer period of time or driving for a limited period of time during parking. The term “automated driving” comprises automated driving with any degree of automation. Illustrative degrees of automation are assisted, partially automated, conditionally automated, highly automated and fully automated driving (with an increasing degree of automation in each case). The aforementioned five degrees of automation correspond to SAE levels 1 to 5 of the SAE J3016 (SAE-Society of Automotive Engineering) standard in the version dated Apr. 30, 2021. In assisted driving (SAE level 1), the system performs the longitudinal or lateral guidance in certain driving situations. In partially automated driving (SAE level 2), the system takes over the longitudinal and lateral guidance in certain driving situations, the driver needing to constantly monitor the system as in the case of assisted driving. In conditionally automated driving (SAE level 3), the system takes over the longitudinal and lateral guidance in certain driving situations without the driver having to constantly monitor the system; the driver must be able to take over the vehicle guidance within a certain time at the request of the system, however. In highly automated driving (SAE level 4), the system takes over the vehicle guidance in certain driving situations, even if the driver does not react to a request for intervention, and so the driver is dispensed with as a fallback level. In fully automated driving (SAE level 5), the system may perform all aspects of the dynamic driving task which are also handled by a human driver under any road and environmental condition.

In addition, within the context of the document, the term “at least partially automated driving or maneuvering” is also understood to mean partially automated, conditionally automated, highly automated and fully automated driving. In other words, the term “at least partially automated driving” is therefore understood to mean a degree of automation of above and including SAE level 2.

A method according to forms of the invention for operating a parking assistance system of an ego vehicle during an at least partially automated search for a parking space comprises receiving environment data, which describe an environment of the ego vehicle, from an environment sensor of the ego vehicle. In addition, the method comprises receiving parking space data from a vehicle in front in the environment of the ego vehicle, wherein the parking space data describe potential parking spaces in front of the ego vehicle in the direction of travel. Finally, the method comprises determining a parking space in front of the ego vehicle in the direction of travel on the basis of the environment data and the parking space data, wherein the parking space is suitable for forward parking of the ego vehicle. In this case, the environment data describes a relative position of the vehicle in front. A driving strategy for the ego vehicle for the at least partially automated search for a parking space can therefore be determined on the basis of the relative position, according to which driving strategy the environment data will be captured in future.

The method can be carried out, for example, by means of a computing device. The computing device may be, for example, in the form of at least one electronic control unit of the vehicle comprising one or more programmable processors. In addition, the computing device may have a computer-readable storage medium, on which a computer program is stored. In order to carry out corresponding method steps, for example the determination of a parking space in front of the ego vehicle in the direction of travel, the computer program can be executed on the computing device.

The method is therefore used to improve the search for a parking space. In particular, the method is intended to be used to improve forward parking into a parking space which was captured by a vehicle in front during passing. The method according to forms of the invention is particularly suitable in one-way streets, in parking areas or the like, in particular when parking areas may be located on both sides of the road or the traffic lane. Parking spaces may denote parallel parking spaces, perpendicular parking spaces, parking spaces arranged obliquely with respect to the road or the like.

Forms of the invention are based on the following idea: in one-way streets or in situations in which it is possible to park on both sides, potential parking spaces may be located both on the left in the direction of travel and on the right in the direction of travel. If a vehicle in front now provides the ego vehicle with information relating to parking spaces, it is conceivable that the vehicle in front reliably captures parking spaces only on one of the two sides on account of the road width or the traffic lane width. Coordination between the vehicle in front and the ego vehicle may make it possible to reliably capture both sides and therefore all potential parking spaces. For example, the ego vehicle can be positioned in such a manner that the ego vehicle is used to reliably capture the potential parking spaces on the left-hand side and the vehicle in front is used to capture the potential parking spaces on the right-hand side. In this case, the ego vehicle preferably moves in an at least partially automated manner. The search for a parking area, in particular also forward parking, can therefore be made more efficient.

First of all, the environment data is received from an environment sensor of the ego vehicle. The environment data may be, for example, a radar, lidar and/or ultrasonic sensor. The use of a camera as an environment sensor is also conceivable. In addition, parking space data can be transmitted from a vehicle in front to the ego vehicle. The vehicle in front may be, for example, a further road user, in particular a further vehicle. The vehicle in front may have similar environment sensors. In other words, the vehicle in front may therefore comprise a radar, lidar and/or ultrasonic sensor and/or a camera. The parking space data may directly represent sensor data from the corresponding environment sensor of the vehicle in front. However, the parking space data may also represent an environment model of the vehicle in front. It is also conceivable for the parking space data to describe potential parking spaces by means of coordinates, an orientation, a width and/or a depth.

The vehicle in front may send the parking space data to the ego vehicle, for example, by means of vehicle-to-vehicle communication (V2V communication for short) or communication via a backend. The ego vehicle can consequently receive the parking space data via the vehicle-to-vehicle communication or via communication with a backend and can use the parking space data, together with the environment data, to determine a parking space for forward parking that is located in front of the ego vehicle in the direction of travel.

So that all potential parking spaces can be reliably covered by the environment data and the parking space data, a relative position of the vehicle in front can be determined on the basis of the environment data. On the basis of the relative position of the vehicle in front, it is possible to determine whether the vehicle in front tends to capture the potential parking spaces on the left-hand side or the potential parking spaces on the right-hand side (in the direction of travel of the ego vehicle). A driving strategy for the ego vehicle can thus be determined on the basis of this information, that is to say on the basis of the relative position. In this context, a driving strategy may be, for example, offset driving of the ego vehicle relative to the vehicle in front. As a result of offset driving, the vehicle in front, for example, can capture the potential parking spaces on the right-hand side and the ego vehicle can capture the potential parking spaces on the left-hand side (in the direction of travel of the ego vehicle).

The vehicle in front need not necessarily move in the same direction of travel as the ego vehicle. The vehicle in front may therefore also be an oncoming vehicle, in particular in larger supermarket parking areas or the like. In addition, the vehicle in front need not be directly in front of the ego vehicle. In other words, it is therefore conceivable for further road users to be between the vehicle in front and the ego vehicle. It is generally advantageous if the method for operating the parking assistance system is carried out in an environment which is distinguished by a restricted width of a traffic lane, in which case the traffic lane is nevertheless so wide that the vehicle in front and/or the ego vehicle may not be able to capture all potential parking spaces on both sides when passing.

By means of the driving strategy determined on the basis of the relative position of the vehicle in front, the ego vehicle can be positioned during the search for a parking space such that all potential parking spaces can be captured in future by means of the parking space data and the environment data. A parking space for forward parking can therefore be reliably found.

A further advantageous embodiment provides for the relative position of the vehicle in front to describe a lateral distance between the vehicle in front and a traffic lane edge. The lateral distance between the vehicle in front and the traffic lane edge may be characteristic of the potential parking spaces which are captured by the vehicle in front. For example, the shorter the lateral distance between the vehicle in front and the right-hand traffic lane edge, the more reliably potential parking spaces on the right-hand side can be detected by the vehicle in front. The relative position of the vehicle in front. The relative position of the vehicle in front, which describes a position of the vehicle in front relative to the traffic lane edge, can therefore first be determined on the basis of the environment data.

If the vehicle in front therefore moves close to the right-hand traffic lane edge, for example, it may be advantageous if the ego vehicle is oriented toward the left-hand traffic lane edge during the at least partially automated search for a parking space. In other words, it can therefore be ensured that all potential parking spaces are reliably captured by the vehicle in front and the ego vehicle.

The traffic lane edge may be, for example, a traffic lane boundary line (line marking), a distance to the shoulder, vehicles to be parked or the like. In other words, the traffic lane edge may thus be boundaries of an area of the environment that can be used.

In addition, it may be advantageous if the driving strategy describes offset positioning of the ego vehicle within the traffic lane. Offset positioning makes it possible for the ego vehicle, together with the vehicle in front, to be able to reliably capture all potential parking spaces. For example, the vehicle in front may capture potential parking spaces on the passenger side, that is to say on the right in the direction of travel, whereas the ego vehicle captures potential parking spaces on the driver's side, that is to say on the left in the direction of travel. All in all, all potential parking spaces are thus captured. Offset positioning may describe a distance between the longitudinal axis of the vehicle in front and the parallel longitudinal axis of the ego vehicle.

A further advantageous embodiment of the method provides for the parking space data to describe the potential parking spaces on the basis of a parking space position, a parking space width, a parking space depth and/or a parking space orientation. It may be advantageous if as few data items as possible are exchanged between the vehicle in front and the ego vehicle. In order to reduce the volume of data, a potential parking space which is captured by the vehicle in front and is described by the parking space data can be described on the basis of individual characteristic parameters of the potential parking space. Important characteristic parameters of the potential parking space may therefore be, for example, the parking space position (that is to say the position of the potential parking space), the parking space width (that is to say the width of the potential parking space), the parking space depth (that is to say the depth of the potential parking space) and/or the parking space orientation (for example an (orientation) angle of the potential parking space). The volume of data can therefore be reduced, for example, in comparison with the transmission of an environment model of the vehicle in front. Overall, the efficiency of the method can therefore be increased.

In addition, it may be advantageous if the parking space data are received via direct vehicle-to-vehicle communication (or car-to-car communication, V2V communication and C2C communication for short, respectively) with the vehicle in front. If the parking space data are directly received from the vehicle in front, that is to say without previously transmitting the data via a backend, time can be saved, on the one hand, and a complicated server architecture can be dispensed with, on the other hand. In principle, a radio technology, for example LTE, 5G or the like, can be used for this purpose. The use of WLAN, Bluetooth, NFC or the like is also conceivable.

An implementation of the vehicle-to-vehicle communication between the vehicle in front and the ego vehicle may be embedded in a cross-OEM standard. It is also conceivable for the method to be implemented in a manufacturer-specific or fleet-specific manner, that is to say only vehicles in a fleet or from a manufacturer participate in the cooperative search for a parking space. This may provide the advantage that an implementation can be implemented more quickly. In addition, fleet-specific requirements can also be considered. Nevertheless, standardization may great advantages. The more road users participate in the cooperative search for a parking space, the higher the functional availability may be.

In this case, it may also be advantageous if the parking space data are received via the direct vehicle-to-vehicle communication after a parking space search request has been output to the vehicle in front. In order to start the method according to the invention or its advantageous embodiment, it may be necessary to initially set up a connection between the vehicle in front and the ego vehicle. It would generally be conceivable for the vehicle in front to permanently provide parking space data. However, this would be inefficient, on the one hand, and unnecessary, on the other hand. Therefore, it may be advantageous if the ego vehicle informs the vehicle in front that it requires a parking space or is on the search for a parking space. For this purpose, the ego vehicle can emit a request, that is to say the parking space search request, to the vehicle in front via the vehicle-to-vehicle communication.

The parking space search request can therefore be used to ensure that the vehicle in front transmits parking space data only when they are actually required. In addition, the parking space search request may be directed to a specific vehicle or a specific vehicle in front. In other words, it is therefore conceivable for the ego vehicle to select a specific vehicle which is intended to provide parking space data. Overall, the search for a parking space can therefore be made considerably more effective and therefore improved overall.

In this case, it may be advantageous if the parking space search request describes a driving strategy for the vehicle in front, wherein the driving strategy for the vehicle in front describes an instruction for positioning the vehicle in front within the traffic lane. The latter is advantageous, in particular, when the vehicle in front is moved in an at least partially automated or automated manner. The ego vehicle can instruct the vehicle in front, for example, if this is actually a vehicle driving directly in front of the ego vehicle, to move close to the right-hand traffic lane edge, such that the vehicle in front captures substantially the potential parking spaces on the right in the direction of travel. In other words, the driving strategy for the vehicle in front may therefore describe positioning of the vehicle in front.

However, it is also conceivable for the driving strategy for the vehicle in front to describe a trajectory for the vehicle in front. For example, it may be advantageous if the vehicle in front moves along a wavy line and thus alternately searches the left-hand side and the right-hand side in the direction of travel for potential parking spaces. The search for a parking space can be further improved as a result. In addition, the search effort may be reduced for the ego vehicle. The search for a parking space can therefore be substantially carried out by the vehicle in front alone.

A computing device according to the invention for an ego vehicle is configured to carry out a method according to the invention and the advantageous configurations thereof. The computing device may be, for example, in the form of an electronic control unit comprising one or more programmable processors.

A computer-readable storage medium according to the invention comprises instructions which, when executed by a computing device, cause the latter to carry out a method according to the invention and the advantageous configurations thereof.

A parking assistance system according to the invention for an ego vehicle comprises a computing device according to the invention which is configured to maneuver the ego vehicle into the determined parking space in an at least partially automated manner. The parking assistance system also comprises an environment sensor which is configured to capture an environment of the ego vehicle and to send corresponding start environment to the computing device. Finally, the parking assistance system according to the invention comprises a vehicle-to-vehicle communication device which is configured to receive parking space data from a vehicle in front and to forward them to the computing device.

A further aspect of the invention relates to a computer program comprising instructions which, when the program is executed by a computing device, cause the latter to carry out a method according to the invention and the advantageous configurations thereof. The invention also relates to a vehicle comprising an assistance system according to the invention. The vehicle may be in the form of an automobile, in particular.

The preferred embodiments presented with respect to the method according to the invention and their advantages accordingly apply to the computing device according to the invention, the computer-readable storage medium according to the invention and the parking assistance system according to the invention. Furthermore, the preferred embodiments presented with respect to the method according to the invention and their advantages also apply to the computer program according to the invention and the vehicle according to the invention.

The invention is now explained in more detail on the basis of preferred exemplary embodiments and with reference to the accompanying drawings, in which:

### BRIEF DESCRIPTION OF THE DRAWINGS

FIG. 1 shows a schematic illustration of an ego vehicle comprising a parking assistance system,

FIG. 2 shows a schematic illustration of an ego vehicle and of a vehicle in front, wherein the ego vehicle is on the search for a parking space and the vehicle in front provides parking space data for this purpose, and

FIG. 3 shows a schematic illustration of the ego vehicle according to FIG. 2 during forward parking.

### DETAILED DESCRIPTION OF THE DRAWINGS

In the figures, identical or functionally identical elements are provided with the same reference signs.

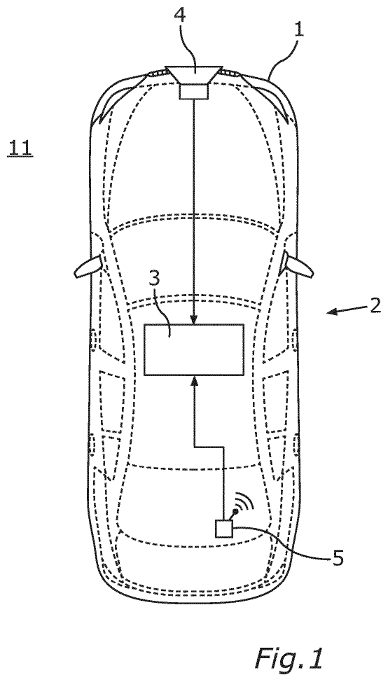

FIG. 1 shows a schematic illustration of an ego vehicle 1 comprising a parking assistance system 2. The parking assistance system 2 comprises a computing device 3, an environment sensor 4 and a vehicle-to-vehicle communication device 5. The computing device 3 is configured to receive environment data, which describe an environment 11 of the ego vehicle 1, from the environment sensor 4. The computing device 3 is also configured to receive parking space data from a vehicle in front 6. The parking space data from the vehicle in front 6 may be transmitted, for example, via vehicle-to-vehicle communication. The parking space data from the vehicle in front 6 may be received by means of the vehicle-to-vehicle communication device 5. The vehicle-to-vehicle communication device 5 may forward the parking space data received in this manner from the vehicle in front 6 to the computing device 3.

The computing device 3 may determine a parking space 7′ in front of the ego vehicle 1 in the direction of travel on the basis of the start environment from the environment sensor 4 and the parking space data from the vehicle in front 6. During the search for a parking space, the ego vehicle 1 can be maneuvered in an at least partially automated manner. In this case, a driving strategy 8 can be determined by the computing device 3, according to which driving strategy the environment data will be captured by the environment sensor 4 in future. In other words, it is therefore possible to determine a driving strategy 8, along which the ego vehicle 1 is moved in an at least partially automated manner during the search for a parking space and the environment data are captured by the environment sensor 4 from a corresponding position.

The search for a parking space can thus be cooperative. Cooperation between the vehicle in front 6 and the ego vehicle 1 makes it possible, for example, for the vehicle in front 6 to search one side of the road for potential parking spaces 7 and for the ego vehicle 1 to search the other side of the road for potential parking spaces 7.

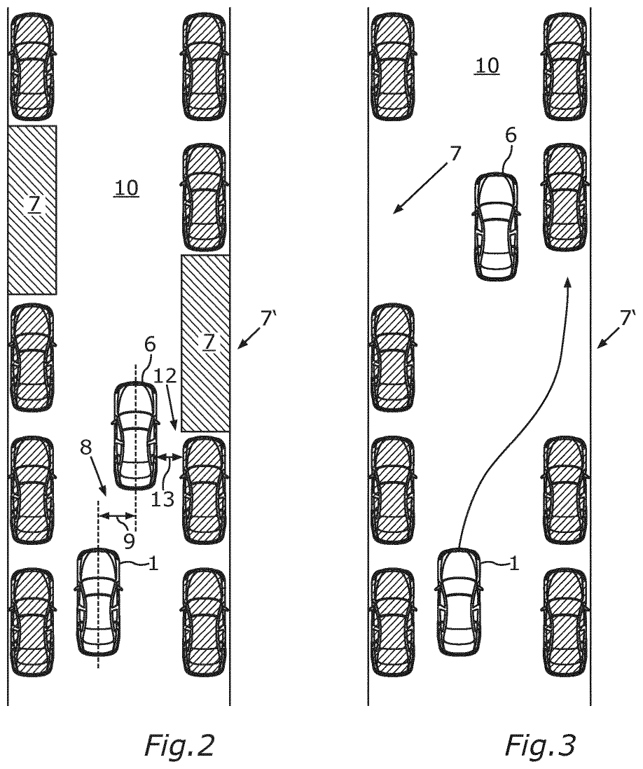

FIG. 2 shows a schematic illustration of the ego vehicle 1 and of the vehicle in front 6, wherein the ego vehicle 1 is on the search for a parking space and the vehicle in front 6 provides parking space data for this purpose. In the exemplary embodiment in FIG. 2, the driving strategy 8 describes offset positioning 9 of the ego vehicle 1 within the traffic lane 10.

A relative position 12 of the vehicle in front 6 can be determined on the basis of the start environment from the environment sensor 4, or the environment data may describe a relative position 12. In the exemplary embodiment in FIG. 2, the relative position 12 of the vehicle in front 6 describes a lateral distance 13 between the vehicle in front 6 and a traffic lane edge (not illustrated in any more detail in FIG. 2).

In the example in FIG. 2, the vehicle in front 6 may capture, in particular, the potential parking space 7 (which is then determined as the parking space 7′ for forward parking that is located in front of the ego vehicle in the direction of travel, see FIG. 3) on the right-hand side in the direction of travel. As a result of the offset positioning 9, the ego vehicle 1 can reliably capture the potential parking space 7 on the left-hand side in the direction of travel by means of the environment sensor 4. Overall, all potential parking spaces 7 can therefore be reliably captured.

FIG. 3 shows a schematic illustration of the ego vehicle 1 according to FIG. 2 during the at least partially automated forward parking into the parking space 7′ on the right-hand side in the direction of travel. The computing device 3 may be configured in this case to maneuver the ego vehicle 1 in an at least partially automated manner.

1.-10. (canceled)

11. A method for operating a parking assistance system of an ego vehicle during an at least partially automated search for a parking space, the method comprising:
receiving environment data, which describes an environment of the ego vehicle, from an environment sensor of the ego vehicle;
receiving parking space data from a vehicle in front in the environment of the ego vehicle, wherein the parking space data describe potential parking spaces in front of the ego vehicle in the direction of travel;
determining a parking space in front of the ego vehicle in the direction of travel on the basis of the environment data and the parking space data, wherein the parking space is suitable for forward parking of the ego vehicle,
wherein the environment data describe a relative position of the vehicle in front; and
wherein a driving strategy for the ego vehicle for the at least partially automated search for a parking space is determined on the basis of the relative position, according to which strategy the environment data will be captured in future.

12. The method according to claim 11, wherein:
the relative position of the vehicle in front describes a lateral distance between the vehicle in front and a traffic lane edge.

13. The method according to claim 11, wherein:
the driving strategy describes offset positioning of the ego vehicle within the traffic lane.

14. The method according to claim 11, wherein:
the parking space data describes the potential parking spaces on the basis of at least one of a parking space position, a parking space width, a parking space depth or a parking space orientation.

15. The method according to claim 11, wherein:
the parking space data is received via direct vehicle-to-vehicle communication with the vehicle in front.

16. The method according to claim 15, wherein:
the parking space data is received via the direct vehicle-to-vehicle communication after a parking space search request has been output to the vehicle in front.

17. The method according to claim 16, wherein:
the parking space search request describes a driving strategy for the vehicle in front, wherein the driving strategy for the vehicle in front describes an instruction for positioning the vehicle in front within the traffic lane.

18. A computing device for an ego vehicle, comprising a processor configured to carry out a method according to claim 11.

19. A computer-readable storage medium comprising instructions which, when executed by a processor, cause the processor to carry out a method according to claim 11.

20. A parking assistance system for an ego vehicle, comprising:
a computing device according to claim 18, which is further configured to maneuver the ego vehicle into the determined parking space in an at least partially automated manner;
an environment sensor which is configured to capture an environment of the ego vehicle and to send corresponding environment data to the computing device; and
a vehicle-to-vehicle communication device which is configured to receive parking space data from a vehicle in front and to forward the received parking space data to the computing device.
